(19) United States
(12) Patent Application Publication
(10) Pub. No.: US 2016/0268075 A1
(43) Pub. Date: Sep. 15, 2016

(54) SWITCH DEVICE

(71) Applicant: KABUSHIKI KAISHA TOKAI RIKA DENKI SEISAKUSHO, Aichi (JP)

(72) Inventors: Hiroaki YAMAGUCHI, Aichi (JP); Kenichi HAMADA, Aichi (JP)

(21) Appl. No.: 15/031,045

(22) PCT Filed: Oct. 6, 2014
(86) PCT No.: PCT/JP2014/076703

§ 371 Date: Apr. 21, 2016

(30) Foreign Application Priority Data
Oct. 22, 2013 (JP) 2013-219087

(51) Int. Cl. H01H 23/30; H01H 23/16

(52) U.S. Cl. CPC H01H 23/30; H01H 23/168; H01H 2221/016

(57) ABSTRACT

A switch device (1) includes the operation knob (20) supported to be swingable relative to a substrate (6), at least a first cam surface and a second cam surface (23a-1, 23b-1) formed along the swinging direction on a substrate-facing side of the operation knob, and first and second switch contacts (Ma, Mb) disposed on the substrate corresponding to the first and second cam surfaces. At a neutral position of the operation knob, the first switch contact and the second switch contact are maintained in mutually opposite ON/OFF states by a cam action of the first cam surface and the second cam surface.

### TECHNICAL FIELD

The present invention relates to a switch device and, in particular, to a switch device provided with a seesaw-type operation knob.

### BACKGROUND ART

One example of switch device for vehicle such as car is a switch device provided with, e.g., a push button switch operated by swinging a seesaw-type operation knob (see, e.g., PTL 1).

The conventional switch device described in PTL 1 is applied to a power window switch mounted in a vehicle. This conventional switch device is provided with a shaft swingably supporting an operation knob, a first push button switch provided on one side of a substrate substantially parallel to the shaft, a second push button switch provided on another side of the substrate, and a third push button switch provided on the substrate at a position near the center between the first push button switch and the second push button switch.

In the neutral state in which a user is not operating the operation knob, any of the buttons is not depressed. The first push button switch is conducted or interrupted through a first operating bar by tilting the operation knob in one direction, and the third push button switch is conducted or interrupted through a third operating bar by further tilting the operation knob in this one direction. The second push button switch is conducted or interrupted through a second operating bar by tilting the operation knob in another direction, and the third push button switch is conducted or interrupted through the third operating bar by further tilting the operation knob in the other direction.

### CITATION LIST

### Patent Literature

[PTL 1]

JP-A-2012-195057

### SUMMARY OF INVENTION

### Technical Problem

In the meantime, depending on the circuit configuration of the circuit board, it may be desired to adapt an operation knob structure in which one of plural opposing switch contacts is conducted or interrupted and another opposing switch contact interrupted or conducted at the neutral position of the operation knob.

However, the conventional switch device described in PTL 1 has a seesaw-type operation knob structure in which plural push button switches are conducted or interrupted all together at the neutral position of the operation knob, and it is not applicable to a circuit configuration in which one of plural push button switches is maintained in a conducted or interrupted state and another push button switch in a interrupted or conducted state at the neutral position of the operation knob.

Thus, it is an object of the invention to provide a switch device that is provided with a seesaw-type operation knob capable of maintaining, at the neutral position of the operation knob, plural opposing switch contacts in mutually opposite ON/OFF states.

### Solution to Problem

According to an embodiment of the invention, provided is a switch device that comprises: an operation knob supported to be swingable relative to a substrate; at least first and second cam surfaces formed along a swinging direction on a substrate-facing side of the operation knob; and first and second switch contacts disposed on the substrate corresponding to the first and second cam surfaces, wherein, at a neutral position of the operation knob, the first switch contact and the second switch contact are maintained in mutually opposite ON/OFF states by a cam action of the first cam surface and the second cam surface allows.

In the switch device defined by [1], the first switch contact is configured to be alternately switchable between an ON or OFF position in one direction from the neutral position and an OFF or ON position in another direction from the neutral position by the cam action of the first cam surface based on a swinging motion of the operation knob, and wherein the second switch contact is configured to be alternately switchable between an OFF and ON position in the one direction from the neutral position and an OFF and ON position in the other direction from the neutral position by the cam action of the second cam surface based on swinging motion of the operation knob.

In the switch device defined by [1] or [2], the device further comprises: a third cam surface formed parallel to the first cam surface; a fourth cam surface formed parallel to the second cam surface; and third and fourth switch contacts that are disposed corresponding to the third cam surface and the fourth cam surface, wherein, at the neutral position of the operation knob, the third switch contact and the fourth switch contact are maintained in an opposite contact state to that of the first switch contact and the second switch contact by a cam action of the third cam surface and the fourth cam surface.

In the switch device defined by [3], the third switch contact is configured to be alternately switchable between an ON or OFF position in one direction from the neutral position and an OFF or OFF position in another direction from the neutral position by the cam action of the third cam surface based on a swinging motion of the operation knob, and wherein the fourth switch contact is configured to be alternately switchable between an OFF or ON position in the one direction from the neutral position and an ON or OFF position in the other direction from the neutral position by the cam action of the fourth cam surface based on the swinging motion of the operation knob.

In the switch device defined by any one of [1] to [4], the first to fourth switch contacts each comprise a fixed contact arranged on the substrate and a movable contact facing the fixed contact, and wherein the movable contact is provided on an inner surface of an elastically deformable rubber dome that applies a force in a direction of moving the operation knob away from the substrate.

In the switch device described in [5], the rubber dome is formed integrally with a rubber sheet that covers a front surface and side surfaces of the substrate.

### Advantageous Effects of Invention

According to an embodiment of the invention, a switch device can be provided that is provided with a seesaw-type operation knob structure capable of maintaining, at the neutral position of the operation knob, plural opposing switch contacts in mutually opposite ON/OFF states.

### BRIEF DESCRIPTION OF DRAWINGS

[FIG. 1]

FIG. 1 is a schematic view showing the front of the driver's seat of an automobile having a switch device in a first embodiment of the invention.

[FIG. 2]

FIG. 2 is an exploded perspective view showing the switch device in the first embodiment.

[FIG. 3]

FIG. 3 is a cross sectional view showing a main portion taken along a line in FIG. 2.

[FIG. 4]

FIG. 4 is a cross sectional view showing the main portion taken along a line IV-IV in FIG. 2.

[FIG. 5A]

FIG. 5A corresponds to FIG. 3 so as to explain an operation of the switch device in the first embodiment, and FIG. 5A is a cross sectional view showing the depressed state of an operation knob.

[FIG. 5B]

FIG. 5B corresponds to FIG. 3 so as to explain an operation of the switch device in the first embodiment, and FIG. 5B is a cross sectional view showing the neutral state of the operation knob.

[FIG. 5C]

FIG. 5C corresponds to FIG. 3 so as to explain an operation of the switch device in the first embodiment, and FIG. 5C is a cross sectional view showing the pull-up state of the

[FIG. 6A]

FIG. 6A corresponds to FIG. 4 so as to explain an operation of the switch device in a second embodiment, and FIG. 6A is a cross sectional view showing the depressed state of the operation knob.

[FIG. 6B]

FIG. 6B corresponds to FIG. 4 so as to explain an operation of the switch device in the second embodiment, and FIG. 6B is a cross sectional view showing the neutral state of the operation knob.

[FIG. 6C]

FIG. 6C corresponds to FIG. 4 so as to explain an operation of the switch device in the second embodiment, and FIG. 6A is a cross sectional view showing the pull-up state of the operation knob.

[FIG. 7]

FIG. 7 is a functional block diagram to explain an operation of the switch device in the first embodiment.

[FIG. 8]

FIG. 8 is an exploded perspective view showing the switch device in the second embodiment.

[FIG. 9]

FIG. 9 is a functional block diagram to explain an operation of the switch device in the second embodiment.

### DESCRIPTION OF EMBODIMENTS

Preferred embodiments of the invention will be specifically described below in conjunction with the appended drawings.

### First Embodiment

(Configuration of the Front of Automobile Driver'S Seat)

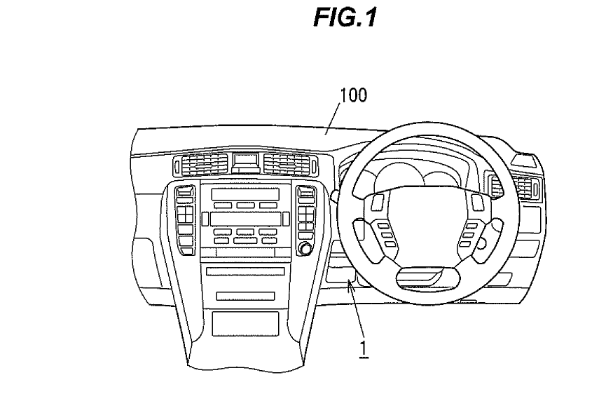

In FIG. 1, a synthetic-resin instrument panel 100 on which instruments and a passenger seat airbag, etc., are installed is arranged along a vehicle width direction in front of the driver's seat of an automobile. A typical switch device 1 in the first embodiment is installed to the instrument panel 100 on the driver's seat side.

The switch device 1 is an electric parking brake switch (EPB switch) allowing a driver etc. to order the activation or deactivation of an electric parking brake (EPB). The electric parking brake is configured that a parking brake is electrically activated or deactivated based on an operation performed on the EPB switch.

(General Configuration of the Switch Device)

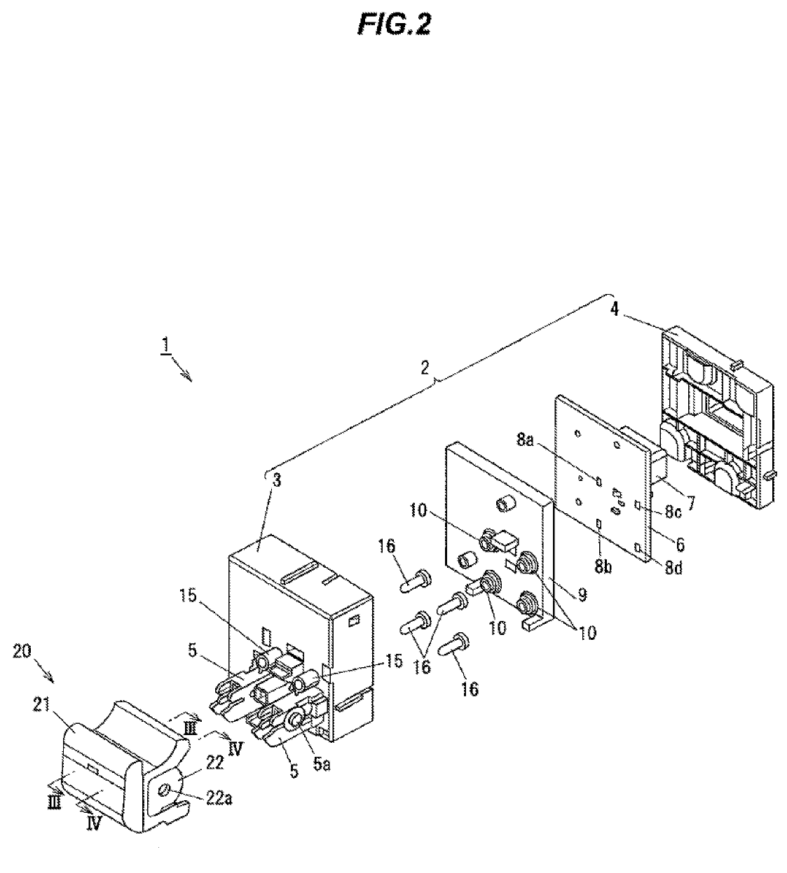

The switch device 1 of which outer appearance is shown in FIG. 2 is composed mainly of a resin case 2 and a seesaw-type resin operation knob 20 supported on the case 2 so as to be swingable. The case 2 is composed of an upper case 3 having an opening on a lower side and a lower case 4 attached so as to close the opening of the upper case 3. Then, switch mechanism components are housed inside the case 2.

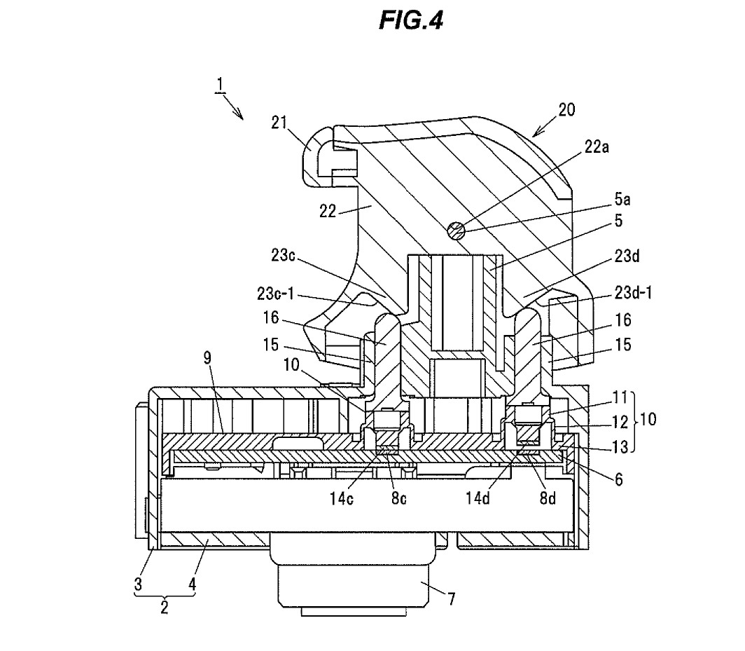

As shown in FIGS. 2 to 4, a pair of support rods 5 is provided upright on an operation knob-facing surface of the upper case 3, and support shafts 5a which swingably support the operation knob 20 are respectively provided on the support rods 5 so as to protrude outward from each other.

Then, a substrate 6 is arranged on an upper case-facing surface of the lower case 4, as shown in FIGS. 2 to 4. A connector 7 is provided on the back side of the substrate 6. The connector 7 is partially exposed to the outside through an opening formed to penetrate the lower case 4.

Four (first to fourth) fixed contacts 8a to 8d are provided on the front surface of the substrate 6, as shown in FIGS. 2 to 4. The fixed contacts 8a to 8d are arranged in two rows (two in each row) along a swinging direction of the operation knob 20.

As shown in FIGS. 2 to 4, a rectangular rubber sheet 9 formed of an elastic member such as silicon or rubber is provided on the front surface of the substrate 6. The rubber sheet 9 is formed in a shape to cover a front surface and side surfaces of the substrate 6. The substrate 6 is sandwiched and held between the upper case 3 and the lower case 4 via the rubber sheet 9, and waterproof or moisture-proof properties of the substrate 6 are thereby ensured.

As shown in FIGS. 2 to 4, four rubber domes 10 each having a hollow therein are formed integrally on the rubber sheet 9 so as to respectively correspond to the four fixed contacts 8a to 8d of the substrate 6. The rubber dome 10 has a movable portion 11, and a cylindrical skirt portion 12 is integrally formed at a lower circumferential edge of the movable portion 11 so as to protrude outward. A thin annular seat 13 horizontally protruding from the lower circumferential edge of the skirt portion 12 is formed integrally with the rubber sheet 9.

As shown in FIGS. 2 to 4, the movable portions 11 of the rubber domes 10 cover the fixed contacts 8a to 8d. Four (first to fourth) movable contacts 14a to 14d are formed on the outer surfaces of the bottoms of the movable portions 11 so as to face the fixed contacts 8a to 8d of the substrate 6. The movable contacts 14a to 14d are arranged in two rows (two in each row) along the swinging direction of the operation knob 20.

As shown in FIGS. 2 to 4, four guide cylindrical portions 15 each having an insertion hole are formed to protrude from the operation knob-facing surface of the upper case 3. A bar-shaped pusher 16 for transmitting an operating force of the operation knob 20 to the rubber dome 10 is movably arranged in each guide cylindrical portion 15. The pusher 16 is configured to be pressed via the rubber dome 10 so as to allow the operation knob 20 to automatically return in a direction of moving away from the substrate 6, and the operation knob 20 automatically returns to the neutral position when the operating force of the operation knob 20 is removed.

As shown in FIGS. 2 to 4, the operation knob 20 is composed of an operating portion 21 to be depressed or pulled up by a finger of an operator, and a cylindrical portion 22 having a portion serving as side surfaces of the operating portion 21. One end of the operating portion 21 is a recessed operation end which is recessed inward. Meanwhile, a shaft bearing hole 22a is formed on the cylindrical portion 22 which is thereby swingably supported by the support shafts 5a of the support rods 5 of the upper case 3.

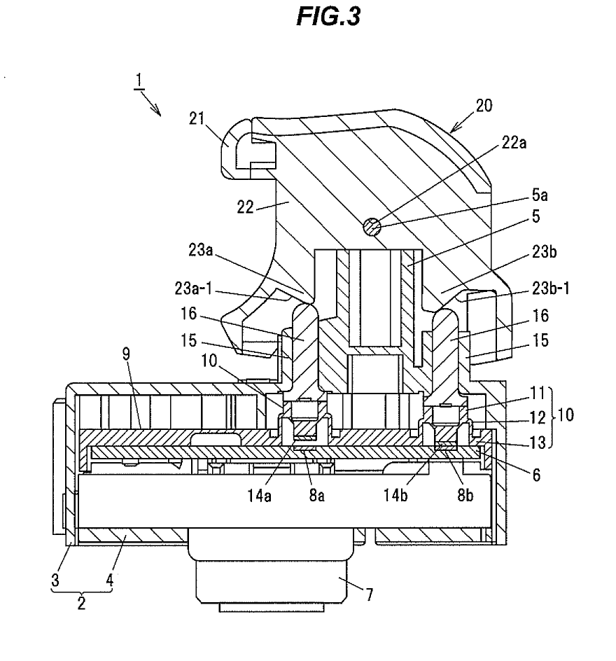

When the operation end of the operation knob 20 is operated, the operation knob 20 rotates about the shaft bearing hole 22a, as shown in FIGS. 3 to 6C. The skirt portion 12 of the rubber dome 10 is elastically deformed via the pusher 16 and one of the movable contacts 14a to 14d of the movable portions 11 is thereby depressed. One of the movable contacts 14a to 14d comes into contact with corresponding one of the fixed contacts 8a to 8d of the substrate 6 and electricity is thereby conducted. When the operating force of the operation knob 20 is removed, the operation knob 20 automatically returns to the neutral position.

(Configuration of the Operation Knob)

As shown in FIGS. 3 to 6C, the main basic structure of the switch device 1 in the first embodiment is a seesaw-type operation knob structure in which ON/OFF of opposing switch contacts composed of the movable contacts 14a to 14d and the fixed contacts 8a to 8d is reversed at the neutral position of the operation knob 20.

As shown in FIGS. 3 to 6C, the operation knob 20 has a configuration in which the pushers 16 arranged in two rows (two in each row) along the swinging direction move in different amounts in a variation pattern corresponding to the cam surface shapes of four (first to fourth) cam portions 23a to 23d, so that one of the opposing switch contacts composed of the movable contacts 14a to 14d and the fixed contacts 8a to 8d is selectively conducted at the neutral position of the operation knob 20.

(Configuration of the Cam Portion of the Operation Knob)

As shown in FIGS. 3 to 6C, the first and second cam portions 23a, 23b and the third and fourth cam portions 23c, 23d are formed in two rows on the inner surface of the cylindrical portion 22 of the operation knob 20 along the swinging direction of the operation knob 20, so as to follow swinging motion of the operation knob 20. The first and second cam portions 23a and 23b are arranged so as to respectively correspond to the first and second movable contacts 14a and 14b. Meanwhile, the third and fourth cam portions 23c and 23d are arranged so as to respectively correspond to the third and fourth movable contacts 14c and 14d.

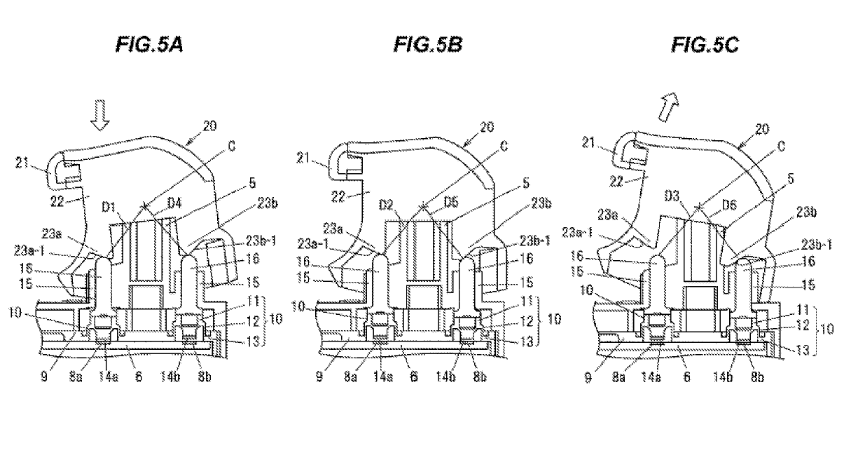

As shown in FIGS. 5A to 5C, the first cam portion 23a is formed such that, from the rotational axis C of the shaft bearing hole 22a of the operation knob 20, a distance to a front edge of a cam surface 23a-1 is smaller than a distance to a rear edge of the cam surface 23a-1.

This cam surface shape of the first cam portion 23a is configured to satisfy a relation of D1>D2=D3, where D1 is a distance between the rotational axis C of the shaft bearing hole 22a of the operation knob 20 and the center of the tip of the pusher 16 at the depressed position, D2 is a distance between the rotational axis C of the shaft bearing hole 22a of the operation knob 20 and the center of the tip of the pusher 16 at the neutral position, and D3 is a distance between the rotational axis C of the shaft bearing hole 22a of the operation knob 20 and the center of the tip of the pusher 16 at the pull-up position.

Thus, the first fixed contact 8a is electrically conducted to the first movable contact 14a at the depressed position of the operation knob 20, and the first fixed contact 8a is not electrically conducted to the first movable contact 14a at the neutral position and pull-up position of the operation knob 20.

Meanwhile, as shown in FIGS. 5A to 5C, the second cam portion 23b is formed such that, from the rotational axis C of the shaft bearing hole 22a of the operation knob 20, a distance to a front edge of a cam surface 23b-1 is smaller than a distance to a rear edge of the cam surface 23b-1.

This cam surface shape of the second cam portion 23b is configured to satisfy a relation of D5=D6>D4, where D4 is a distance between the rotational axis C of the shaft bearing hole 22a of the operation knob 20 and the center of the tip of the pusher 16 at the depressed position, D5 is a distance between the rotational axis C of the shaft bearing hole 22a of the operation knob 20 and the center of the tip of the pusher 16 at the neutral position, and D6 is a distance between the rotational axis C of the shaft bearing hole 22a of the operation knob 20 and the center of the tip of the pusher 16 at the pull-up position.

Thus, the second fixed contact 8b is not electrically conducted to the second movable contact 14b at the depressed position of the operation knob 20, and the second fixed contact 8b is electrically conducted to the second movable contact 14b at the neutral position and pull-up position of the operation knob 20.

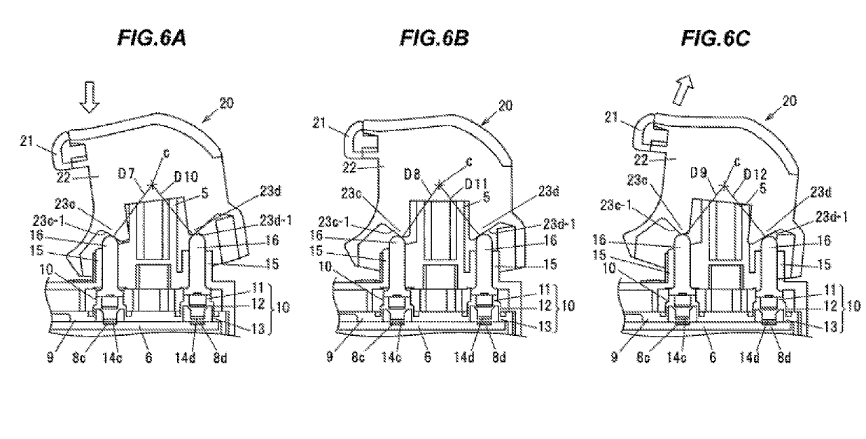

As shown in FIGS. 6A to 6C, the third cam portion 23c is formed such that, from the rotational axis C of the shaft bearing hole 22a of the operation knob 20, a distance to a front edge of a cam surface 23c-1 is smaller than a distance to a rear edge of the cam surface 23c-1 and is equal to the distance to the cam surface 23a-1 of the first cam portion 23a arranged parallel to the third cam portion 23c.

This cam surface shape of the third cam portion 23c is configured to satisfy a relation of D7=D8>D9, where D7 is a distance between the rotational axis C of the shaft bearing hole 22a of the operation knob 20 and the center of the tip of the pusher 16 at the depressed position, D8 is a distance between the rotational axis C of the shaft bearing hole 22a of the operation knob 20 and the center of the tip of the pusher 16 at the neutral position, and D9 is a distance between the rotational axis C of the shaft bearing hole 22a of the operation knob 20 and the center of the tip of the pusher 16 at the pull-up position.

Thus, the third fixed contact 8c is electrically conducted to the third movable contact 14c at the depressed position and neutral position of the operation knob 20, and the third fixed contact 8c is not electrically conducted to the third movable contact 14c at the pull-up position of the operation knob 20.

Meanwhile, as shown in FIGS. 6A to 6C, the fourth cam portion 23d is formed such that, from the rotational axis C of the shaft bearing hole 22a of the operation knob 20, a distance to a front edge of a cam surface 23d-1 is smaller than a distance to a rear edge of the cam surface 23d-1 and is equal to the distance to the cam surface 23b-1 of the second cam portion 23b arranged parallel to the fourth cam portion 23d.

This cam surface shape of the fourth cam portion 23d is configured to satisfy a relation of D12>D10=D11, where D10 is a distance between the rotational axis C of the shaft bearing hole 22a of the operation knob 20 and the center of the tip of the pusher 16 at the depressed position, D11 is a distance between the rotational axis C of the shaft bearing hole 22a of the operation knob 20 and the center of the tip of the pusher 16 at the neutral position, and D12 is a distance between the rotational axis C of the shaft bearing hole 22a of the operation knob 20 and the center of the tip of the pusher 16 at the pull-up position.

Thus, the fourth fixed contact 8d is not electrically conducted to the fourth movable contact 14d at the depressed position and neutral position of the operation knob 20, and the fourth fixed contact 8d is electrically conducted to the fourth movable contact 14d at the pull-up position of the operation knob 20.

(Circuit Configuration of the Switch Device)

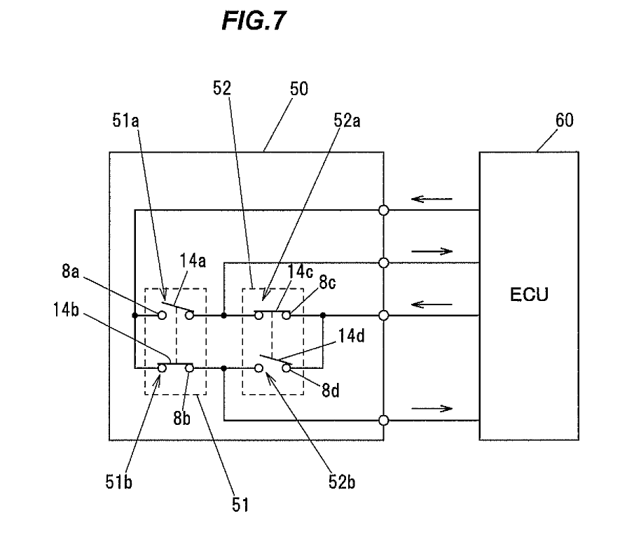

As shown in FIG. 7, an electronic control unit (hereinafter, referred to “ECU”) 60 and a switch circuit 50 are provided in the circuit configuration of the switch device 1.

The ECU 60 is formed of, e.g., a microcomputer having a CPU (Central Processing Unit) performing calculation and processing, etc., of the acquired data according to a stored program, and various components such as RAM and ROM, etc., which are semiconductor memories. The ECU 60 activates a parking brake actuator (not shown) to apply a braking force to wheels based on a signal sent from the switch circuit 50.

The operation performed on the operation knob 20 is transmitted to the switch circuit 50, as shown in FIG. 7. The switch circuit 50 is formed to have a dual-circuit system provided with a first switch circuit 51 and a second switch circuit 52.

In the first switch circuit 51, a first switch contact 51a composed of the first fixed contact 8a and the first movable contact 14a is arranged parallel to a second switch contact 51b composed of the second fixed contact 8b and the second movable contact 14b, as shown in FIG. 7.

Meanwhile, in the second switch circuit 52, a third switch contact 52a composed of the third fixed contact 8c and the third movable contact 14c is arranged parallel to a fourth switch contact 52b composed of the fourth fixed contact 8d and the fourth movable contact 14d, as shown in FIG. 7.

At the neutral (normal) position at which the operation knob 20 is not operated by a driver, the second switch contact 51b of the first switch circuit 51 and the third switch contact 52a of the second switch circuit 52 are both maintained in the ON state, as shown in FIGS. 5B, 6B and 7. On the other hand, the first switch contact 52a of the first switch circuit 52 and the fourth switch contact 52b of the second switch circuit 52 are maintained in the OFF state.

That is, the switch circuit 50 is formed as a normally-closed circuit in which one of the switch contacts 51a, 51b, 52a and 52b is ON at the neutral position of the operation knob 20 and the first switch circuit 51 or the second switch circuit 52 is thereby a closed circuit.

When the driver selects a depressing operation (push operation) of the operation knob 20, the first switch contact 51a of the first switch circuit 51 is turned on and the third switch contact 52a of the second switch circuit 52 is maintained in the ON state, as shown in FIGS. 5A, 6A and 7. On the other hand, the second switch contact 51b of the first switch circuit 51 is turned off and the fourth switch contact 52b of the second switch circuit 52 is maintained in the OFF state.

When the driver selects a pull-up operation (pull operation) of the operation knob 20, the first switch contact 51a of the first switch circuit 51 is maintained in the OFF state and the third switch contact 52a of the second switch circuit 52 is turned off, as shown in FIGS. 5C, 6C and 7. On the other hand, the second switch contact 51b of the first switch circuit 51 is maintained in the ON state and the fourth switch contact 52b of the second switch circuit 52 is turned on.

The circuit configuration of the switch device 1 described above allows the ECU 60 to detect the ON/OFF state of the first to fourth switch contacts 51a, 51b, 52a and 52b and to detect failure or malfunction of the first switch circuit 51 or the second switch circuit 52.

Table 1 below summarizes the operation of the switch device 1 which changes in response to the operated state of the operation knob 20.

TABLE 1

| | |
|---|---|
| First | Second |
| switch circuit | switch circuit |
| Switch contact | Switch contact |

| Operated state | First | Second | Third | Fourth |
|---|---|---|---|---|
| Push | ON | OFF | ON | OFF |
| Normal | OFF | ON | ON | OFF |
| Pull | OFF | ON | OFF | ON |

(Effects of the First Embodiment)

By using the switch device 1 configured as described above, the following effects are obtained in addition to the above-described effects.

(1) It is possible to effectively obtain an opposing switch contact structure in which one of the switch contacts 51a and 51b is in a conducting or non-conducting state while one of the switch contacts 52a and 52b is in a non-conducting or conducting state at the neutral position of the operation knob 20.

(2) It is possible to adapt the opposing switch contact structure for the normally-closed circuit.

(3) An unbalanced force applied to the pushers 16 can be reduced by providing plural opposing switch contacts composed of the fixed contacts 8a to 8d and the movable contacts 14a to 14d, which allows the operation knob 20 to be reliably operated.

(4) The configuration is simple and adaptable to the switch circuit 50 having plural opposing switch contacts.

(5) The simple component structure allows constituent components to be reduced and it is thereby possible to reduce the manufacturing cost and the assembly cost, etc.

### Second Embodiment

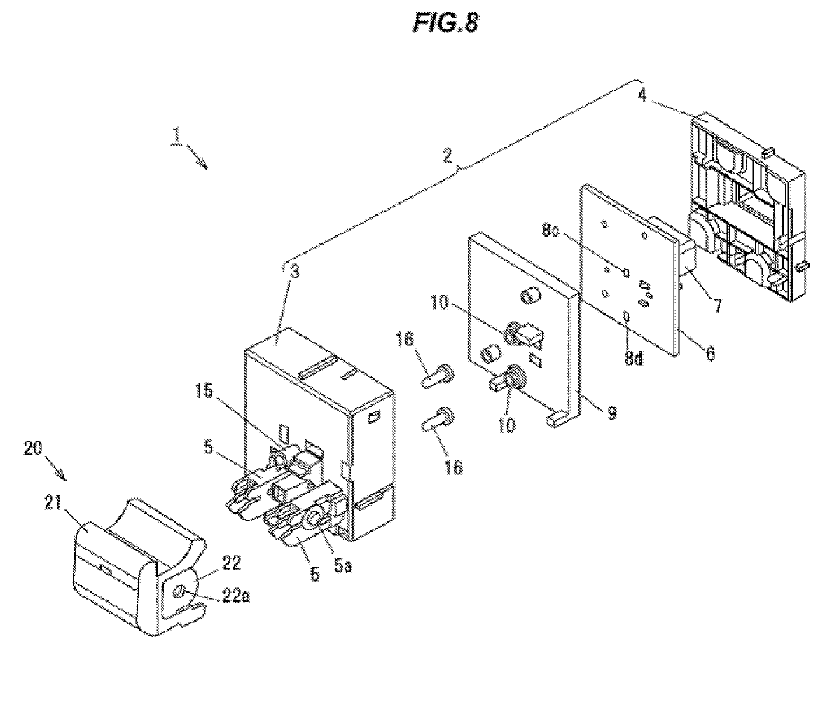

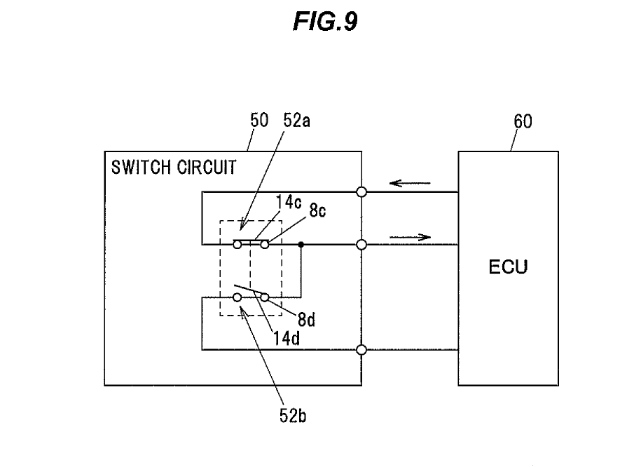

Referring to FIGS. 8 and 9, an example configuration of the switch device 1 in the second embodiment is shown in the drawings.

In the first embodiment, the seesaw-type operation knob 20 has the cam portions 23a to 23d arranged in two rows (two in each row) along the swinging direction of the operation knob 20 and is applied to the four-contact circuit configuration. The second embodiment is different from the first embodiment in that the seesaw-type operation knob 20 has the cam portions 23c and 23d arranged in a row along the swinging direction of the operation knob 20 and is applied to the two-contact circuit configuration.

The remaining configuration is the same as that in the first embodiment. Therefore, the same reference numerals as those used in the first embodiment will be used and the detailed explanation thereof will be omitted.

The third and fourth switch contacts 52a and 52b arranged to respectively correspond to the third and fourth cam portions 23c and 23d in the first embodiment are now referred to as first and second switch contacts in the second embodiment.

(General Configuration of the Switch Device)

As shown in FIG. 8, two guide cylindrical portions 15 each having an insertion hole are formed to protrude from the operation knob-facing surface of the upper case 3. The bar-shaped pushers 16 for transmitting an operating force of the operation knob 20 to the rubber domes 10 are respectively movably arranged in the insertion holes.

As shown in FIG. 8, two fixed contacts 8c and 8d are formed on the front surface of the substrate 6 which is provided on the lower case 4 on a side facing the upper case 3. The fixed contacts 8c and 8d are arranged in a row along the swinging direction of the operation knob 20. Two movable contacts 14c and 14d facing the fixed contacts 8c and 8d are formed on the rubber domes 10 which are formed integrally on the rubber sheet 9.

(Circuit Configuration of the Switch Device)

As shown in FIG. 9, the switch circuit 50 of this switch device 1 has a two-contact structure in which the first switch contact 52a composed of the fixed contact 8c and the movable contact 14c is arranged parallel to the second switch contact 52b composed of the fixed contact 8d and the movable contact 14d.

At the neutral (normal) position at which the operation knob 20 is not operated by a driver, one of the switch contacts 52a and 52b is in a non-conducting and the other of the switch contacts 52a and 52b is in a conducting state, as shown in FIG. 9.

In the illustrated example, the switch contact 52a is maintained in the ON state at the neutral (normal) position at which the operation knob 20 is not operated by a driver, as shown in FIGS. 6B and 9. On the other hand, the switch contact 52b is maintained in the OFF state. That is, the switch circuit 50 is formed as a normally-closed circuit in which the switch contact 52a or the switch contact 52b is ON at the neutral position of the operation knob 20 and one of switch circuits is thereby a closed circuit.

When the driver selects a depressing operation (push operation) of the operation knob 20, the switch contact 52a is turned off while the switch contact 52b is turned on, as shown in FIGS. 6A and 9.

When the driver selects a pull-up operation (pull operation) of the operation knob 20, the switch contact 52a is maintained in the ON state. On the other hand, the switch contact 52b is maintained in the OFF state, as shown in FIGS. 6C and 9.

Table 2 below summarizes the operation of the switch device 1 which changes in response to the operated state of the operation knob 20.

TABLE 2

| Operated state | First switch contact | Second switch contact |
|---|---|---|
| Push | ON | OFF |
| Normal | OFF | ON |
| Pull | OFF | ON |

(Effects of the First Embodiment)

By using the switch device 1 configured as described above, the following effects are obtained in addition to the above-described effects.

The seesaw-type operation knob 20 having the cam portion 23c and 23d arranged in a row along the swinging direction of the operation knob 20 can be applied to the normally-closed circuit.

### Modifications

Although the switch device 1 of the invention has been described based on each embodiment and the illustrated examples, the invention is not intended to be limited to each embodiment and the illustrated examples, and the various kinds of embodiments can be implemented without departing from the gist thereof. The following modifications of the invention can be implemented.

(1) For example, the shape of the cam surfaces 23a-1 to 23d-1 may be formed by appropriately combining, e.g., a non-linear shape and a linear shape in which variation in a distance between the rotational axis C of the shaft bearing hole 22a of the operation knob 20 and the cam surface varies in a quadratic curve or varies in a linear manner, by which the amount of movement of the pushers 16 due to cam action of the cam surface based on the swinging motion of the operation knob 20 can be set.

(2) Instead of the configuration in which the opposing switch contacts composed of the fixed contacts 8a to 8d and the movable contacts 14a to 14d are turned on or off by the cam surfaces 23a-1 to 23d-1 and the pushers 16, the opposing switch contacts may be configured to be turned on or off directly by the cam surfaces 23a-1 to 23d-1 without interposition of the pushers 16.

(3) The operation of the switch device 1 which changes in response to the operated state of the operation knob 20 is not limited to those in each embodiment and the illustrated examples, and it is obvious that it is possible to reverse ON/OFF of the opposing switch contacts by appropriately combining the shapes of the cam surfaces 23a-1 to 23d-1.

(4) Although the opposing switch contacts composed of the fixed contacts 8a to 8d of the substrate 6 and the movable contacts 14a to 14d of the rubber domes 10 have been described as an example in each embodiment, it is not limited thereto. It is possible to use various mechanical contact mechanisms such as push switch.

(5) Although the electric parking brake switch has been described as an example in each embodiment, it is not limited thereto. It is applicable to, e.g., a power window switch.

(6) The switch device 1 in each embodiment can be effectively used in various vehicles, e.g., working vehicles such as agricultural machineries, construction machineries and transporting machines, and automobiles.

Although the typical embodiments, modifications and illustrated examples of the invention have been described, it is obvious from the above description that the invention according to claims is not to be limited to the embodiments, modifications and illustrated example described above. Therefore, it should be noted that all combinations of the features described in the embodiment and illustrated example are not necessary to solve the problem of the invention

### INDUSTRIAL APPLICABILITY

The invention is applicable to e.g. electric parking brake switches and power window switches.

### REFERENCE SIGNS LIST

1: SWITCH DEVICE
2: CASE
3: UPPER CASE
4: LOWER CASE
5: SUPPORT ROD
5a: SUPPORT SHAFT
6: SUBSTRATE
7: CONNECTOR
8a to 8d: FIRST TO FOURTH FIXED CONTACTS
9: RUBBER SHEET
10: RUBBER DOME
11: MOVABLE PORTION
12: SKIRT PORTION
13: SEAT
14a to 14d: FIRST TO FOURTH MOVABLE CONTACTS
15: GUIDE CYLINDRICAL PORTION
16: PUSHER
20: OPERATION KNOB
21: OPERATING PORTION
22: CYLINDRICAL PORTION
22a: SHAFT BEARING HOLE
23a to 23d: FIRST TO FOURTH CAM PORTIONS
23a-1 to 23d-1: FIRST TO FOURTH CAM SURFACES
50: SWITCH CIRCUIT
51: FIRST SWITCH CIRCUIT
51a: FIRST SWITCH CONTACT
51b: SECOND SWITCH CONTACT
52: SECOND SWITCH CIRCUIT
52a: THIRD SWITCH CONTACT
52b: FOURTH SWITCH CONTACT
60: ECU
100: INSTRUMENT PANEL
C: ROTATIONAL AXIS
D1 to D12: DISTANCE

1. A switch device, comprising:
an operation knob supported so as to be swingable relative to a substrate;
at least first and second cam surfaces formed along a swinging direction on a substrate-facing side of the operation knob; and
first and second switch contacts disposed on the substrate corresponding to the first and second cam surfaces,
wherein, at a neutral position of the operation knob, the first switch contact and the second switch contact are maintained in mutually opposite ON/OFF states by a cam action of the first cam surface and the second cam surface.

2. The switch device according to claim 1, wherein the first switch contact is configured to be alternately switchable between an ON or OFF position in one direction from the neutral position and an OFF or ON position in another direction from the neutral position by the cam action of the first cam surface based on a swinging motion of the operation knob, and
wherein the second switch contact is configured to be alternately switchable between an OFF or ON position in the one direction from the neutral position and an ON or OFF position in the other direction from the neutral position by the cam action of the second cam surface based on the swinging motion of the operation knob.

3. The switch device according to claim 1, further comprising:
a third cam surface formed parallel to the first cam surface;
a fourth cam surface formed parallel to the second cam surface; and
third and fourth switch contacts that are disposed corresponding to the third cam surface and the fourth cam surface,
wherein, at the neutral position of the operation knob, the third switch contact and the fourth switch contact are maintained in an opposite contact state to that of the first switch contact and the second switch contact by a cam action of the third cam surface and the fourth cam surface.

4. The switch device according to claim 3, wherein the third switch contact is configured to be alternately switchable between an ON or OFF position in one direction from the neutral position and an OFF or ON position in another direction from the neutral position by the cam action of the third cam surface based on a swinging motion of the operation knob, and
wherein the fourth switch contact is configured to be alternately switchable between an OFF or ON position in the one direction from the neutral position and an ON or OFF position in the other direction from the neutral position by the cam action of the fourth cam surface based on the swinging motion of the operation knob.

5. The switch device according to claim 1, wherein the first and second switch contacts each comprise a fixed contact arranged on the substrate and a movable contact facing the fixed contact, and
wherein the movable contact is provided on an inner surface of an elastically deformable rubber dome that applies a force in a direction of moving the operation knob away from the substrate.

6. The switch device according to claim 5, wherein the rubber dome is formed integrally with a rubber sheet that covers a front surface and side surfaces of the substrate.

7. The switch device according to claim 3, wherein the third and fourth switch contacts each comprise a fixed contact arranged on the substrate and a movable contact facing the fixed contact, and
wherein the movable contact is provided on an inner surface of an elastically deformable rubber dome that applies a force in a direction of moving the operation knob away from the substrate.

8. The switch device according to claim 7, wherein the rubber dome is formed integrally with a rubber sheet that covers a front surface and side surfaces of the substrate.
